(19) United States
(12) Patent Application Publication
(10) Pub. No.: US 2005/0044222 A1
(43) Pub. Date: Feb. 24, 2005

(54) Method of exchanging test processing information

(76) Inventor: Kazuma Sekiya, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/872,382

(22) Filed: Jun. 22, 2004

(30) Foreign Application Priority Data
Jun. 26, 2003 (JP) 2003-182540

(51) Int. Cl. G06F 15/16; G06F 15/173

(52) U.S. Cl. 709/225; 709/229; 709/217; 709/219

(57) ABSTRACT

A method for exchanging test processing information in a network through which a user-side information input means, a device maker-side information input means, and an information server, including the steps of: a device maker entering a test processing request form from the maker-side information input means to store the test processing request form at a given address in the first storage means of the information server; and a user entering a password for accessing the test processing request form through the user-side information input means to store the password in the third storage means of the information server. The method can prevent an unauthorized access by a third party and facilitate the countermeasure therefor, in the case where the device maker and the user thereof online exchange information concerning a test processing condition, etc.

### BACKGROUND OF THE INVENTION

1. Field of the Invention

The present invention relates to a method of online exchanging information, such as a request for test processing or the results of the test processing, between a user that is to buy a processing device or a user that has already bought the device and a maker of the processing device. More specifically, it relates to a method of facilitating the management of accesses with respect to test processing information.

2. Related Art

In order to confirm a processing condition suitable for processing a workpiece, a user that is to buy a processing device or a user that has already bought the device may previously make a request for test processing to a processing device maker which manufactures and deals in the processing device, and demand that the maker should submit data concerning the processing condition, etc. In this case, a sales representative of the processing device maker holds a meeting about a condition of a workpiece, the procedure of test processing, its time schedule, etc. with a responsible person on the user side to prepare a letter of request for test processing and hands the letter to a person in charge of test processing on the maker side thereby to instruct the device maker on the test processing.

However, there is the sales representative between the user-side responsible person and the person in charge of test processing, and therefore the person in charge of test processing is to carry out the test processing according to the letter of request for test processing prepared by the sales representative and to prepare the data. As a result, the results which the user-side responsible person has intended cannot be obtained.

Further, there is a problem as described below. In the case where the sales representative isn't necessarily familiar with the operationality, function, and performance of the processing device, the sales representative cannot prepare the letter of request for test processing smoothly. As a result, it takes extremely long time until the test processing is started, which interferes with the business activities.

Therefore, there has been proposed a system which allows a user-side responsible person and a maker-side person in charge of test processing to directly exchange information online in parallel with confirming the details thereof (see e.g. JP-A-2002-49659).

However, a processing condition for a processing device is a kind of secret information important in that the quality of products manufactured using the processing device depends on the processing condition, and an unauthorized access by a third party may cause the leakage of the secret information in a system such that the information is exchanged online. Further, it is a burden on a device maker to take measures to cope with an unauthorized access.

Therefore, the objects of the invention are to prevent an unauthorized access by a third party and to facilitate the countermeasure therefor, in the case where a processing device maker and a user thereof online exchange information concerning a processing condition, etc.

### SUMMARY OF THE INVENTION

As an embodied means to solve the above problem, the invention provides a test processing information exchange method for exchanging information involved in a test processing performed by a device maker between the device maker and a user in a network through which a user-side information input means, a device maker-side information input means, and an information server are connected, the method comprising steps of: the device maker preparing a test processing request form and entering the test processing request form and an address for addressing the test processing request form into the information server from the maker-side information input means; and the user setting a password unique to the user and entering the password into the information server, the password intended for the user to enter the address from the user-side information input means, to arrive at the test processing request form, and to bring the test processing request form into its open state, wherein the user enters the address and the password from the user-side information input means, and accesses the test processing request form in the information server, thereby to exchange the information involved in a test processing with the device maker on the test processing request form.

The method may further include a step of: the user setting an auxiliary password in addition to the password and entering the auxiliary password into the information server from the user-side information input means, the user enters the address and the auxiliary password from the user-side information input means, and accesses the test processing request form in the information server, thereby to exchange the information involved in a test processing with the device maker on the test processing request form.

The information server may include at least: a first storage means for storing the test processing request form; a second storage means for storing the address for addressing the test processing request form stored in the first storage means; a third storage means for storing the password; an address checking means for checking an address entered from the information input means with the address stored in the second storage means; and a password checking means for checking a password entered from the information input means with the password stored in the third storage means, and the user-side information input means is capable of accessing the test processing request form stored in the first storage means through the address checking means and the password checking means.

The information server may include: a fourth storage means for storing the auxiliary password; and an auxiliary password checking means for checking an auxiliary password entered from the information input means with the auxiliary password stored in the fourth storage means, and the user-side information input means is capable of accessing the test processing request form stored in the first storage means through the address checking means and the auxiliary password checking means.

According to the invention as arranged above, a user who has first accessed a certain address is to set a password, the test processing information server does not participate in a new password setting, and the new password is set and managed under the responsibility of a processing device user. Therefore, the processing device maker does not need to manage the password and a third party cannot access the test processing information unless the party acquires the password from the processing device user. Thus, the leakage of secret information can be prevented.

Also, the test processing information server does not participate in the auxiliary password setting. The assistant selection and the auxiliary password setting are performed under the responsibility of the processing device user. Since a responsible person on the user side can decide an assistant who can use an auxiliary password, the device maker does not need to manage on this point.

### BRIEF DESCRIPTION OF THE DRAWING

FIG. 1 is an illustration showing a configuration of the system used for embodying the invention; and

FIG. 2 is an illustration showing an example of the test processing request form.

### DETAILED DESCRIPTION OF PREFERRED EMBODIMENT

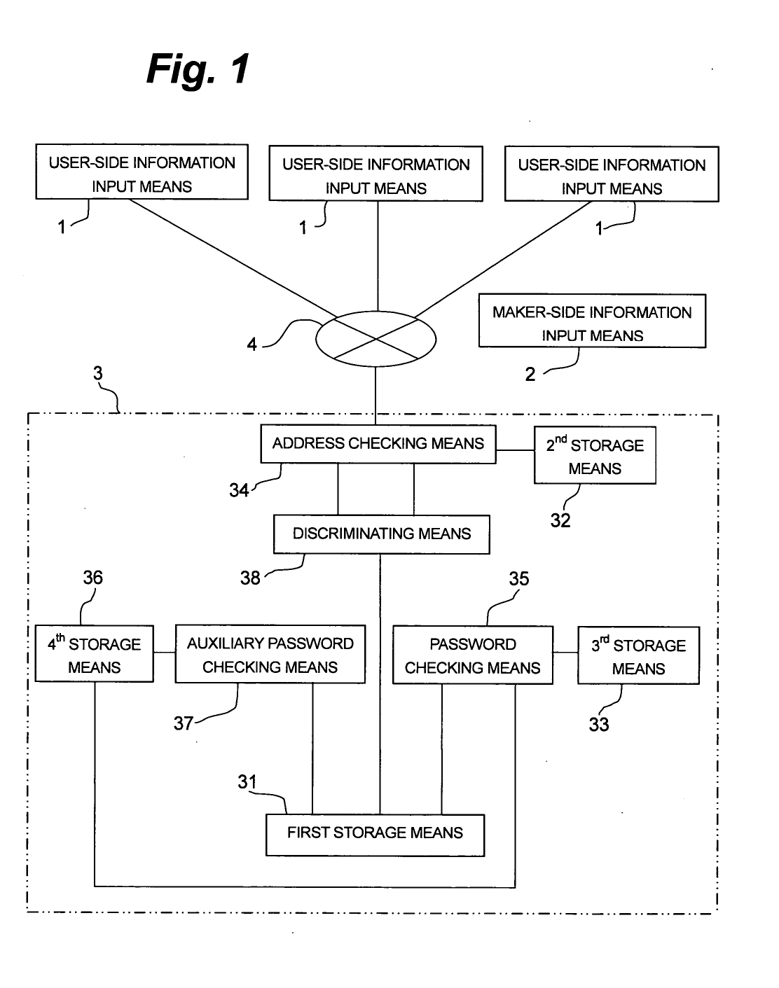

An example of the embodiment of the invention will be described in reference to the drawings. A configuration according to the invention is such that a user-side information input means 1, a maker-side information input means 2 and an information server 3 are connected through a network 4 as shown in FIG. 1, wherein information involved in a test processing performed by the device maker is exchanged between a user and its device maker. Incidentally, the number of information input means is limited to the example illustrated in the drawing neither on the user side nor on the device maker side. In addition, the maker-side information input means 2 and the information server 3 may be directly connected to each other.

The user-side information input means 1 is a unit operated by a user who has bought the device from the device maker or by a responsible person or its assistant of a user who is to buy the device. The unit is composed of a personal computer (PC), for example. In contrast, the maker-side information input means 2 is a unit operated by a person in charge of test processing of the device maker and the unit is composed of, for example, a personal computer. The user-side information input means 1 and the maker-side information input means 2 both include input means, such as a keyboard and a mouse, and display means, such as a display device.

The information server 3 includes: a first storage means 31 for storing a test processing request form consisting of information involved in a test processing including the details of the test processing which a user requests the device maker to conduct; a second storage means 32 for storing an address for addressing the test processing request form stored in the first storage means 31; a third storage means 33 for storing a password required at a time of accessing the test processing request form; an address checking means 34 for checking an address entered from the information input means with the address stored in the second storage means 32; and a password checking means 35 for checking a password entered from the information input means with the password stored in the third storage means 33.

In the example shown in FIG. 1, the information server 3 includes a fourth storage means 36 for storing an auxiliary password. The auxiliary password is used when an assistant other than a responsible person on a user side accesses the test processing request form. The fourth storage means 36 may store a plurality of auxiliary passwords. More specifically, the responsible person on the user side may set a password for the assistant to store it in the fourth storage means 36 after having passed the password checking means 35.

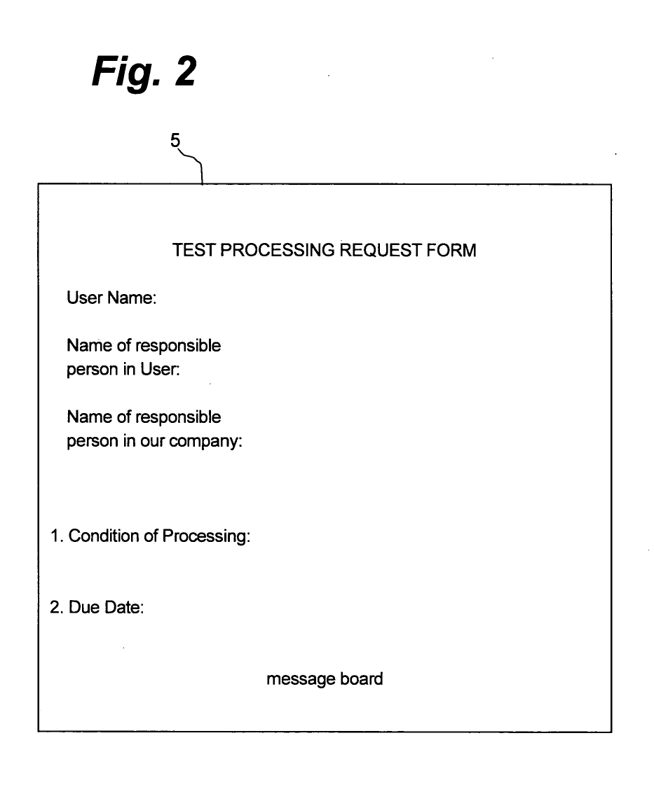

The first storage means 31 is composed of a storage device such as a memory or a disk, which stores a test processing request form 5 consisting of, for example, data having the format shown in FIG. 2. The test processing request form 5 is prepared by the device maker and it can be displayed on the screens of the user-side information input means 1 and maker-side information input means 2. In addition, it is possible to write information including a character and a numeral into the test processing request form 5 from both the information input means.

The second storage means 32 is composed of a storage device such as a memory or a disk, and it stores an address for addressing the test processing request form in the information server 3, i.e. an address indicating the place where the test processing request form is stored. In the case where there are two or more users and a plurality of test processing request forms, a different address is stored for each user.

The third storage means 33 is composed of a storage device such as a memory or a disk, which stores a password unique to the user decided by the user. The password is one which allows the information input means 1 to arrive at the test processing request form to bring the test processing request form into its open state, i.e. a password for making the test processing request form readable and writable. In the case where there are two or more users and a plurality of test processing request forms, a different password is stored for each user.

The address checking means 34 checks an address specified from the information input means 1, 2 with the address stored in the second storage means 32. If the specified address agrees with the stored one, the address checking means 34 judges that an access to the test processing request form stored at the address is attempted.

When an address is specified from the information input means to try accessing the test processing request form, the password checking means 35 checks an password entered and specified at the time of the access with the password corresponding to the address previously stored in the third storage means 33 by a user. When the passwords agree with each other, the password checking means 35 permits reading and writing with respect to the test processing request form stored at that address; otherwise password checking means 35 rejects the access.

On the device maker side, a test processing request form is prepared and stored at a given address in the first storage means 31, an address is entered from the information input means 2 and stored in the second storage means 32, and the address is notified the user previously. In the case where there are two or more users, the maker notifies each user only of a user-specific address where a test processing request form for the user is stored.

When a user tries to make the information input means 1 display details of a test processing request form specific to the user or to write information into the test processing request form, the user enters the address notified to the user by the device maker and accesses the test processing request form.

Then, the address checking means 34 of the informaton server 3 reads an address entered from the information input means 1, and checks if the address is present in the second storage means 32. At this time, if the address is present there, the address checking means 34 transmits the information about that to the password checking means 35. In contrast, if the address is not present in the second storage means 32, the address checking means 34 sends the informaton input means 1 the informaton that the access is rejected, and makes the informaton input means 1 display that informaton.

On receiving the information that the address specified by the informaton input means 1 is present in the second storage means 32, the password checking means 35 transmits either the informaton for password setting or the informaton for password entry to the informaton input means 1 to display the information on the screen thereof. In the case where a user has not set any password yet, a password-setting page is displayed on the screen. Then, the user enters a new password thereinto to send the password to the information server 3. The information server 3 receives the password and stores the received password in the third storage means 33.

In the case where a user specifies an address from the informaton input means 1 to access the test processing request form after a password entered from the informaton input means 1 has been stored in the third storage means 33, the address checking means 34 checks the specified address with the address stored in the second storage means 32. Then, if the address specified by the user agrees with the stored one, the password checking means 35 makes the informaton input means 1 display the information for requesting password entry on the screen thereof. At that time, if the responsible person enters a password, then the password is transmitted to the information server 3.

The password checking means 35 checks the received password with a password stored in the third storage means 33. Then, if the received password agrees with the stored one, the password checking means 35 permits an access to the test processing request form which the information input means 1 has identified based on the address, reads the test processing information form from the first storage means 31, and sends the test processing information form to the information input means 1 to display the test processing form on the screen thereof, thereby bringing the test processing form into a condition where information can be written thereinto. In contrast, if the received password does not agree with the stored one, the password checking means 35 judges that an unauthorized access is attempted, and rejects the access. Therefore, the password is intended to bring the test processing request form into its open state, i.e. a state such that information can be displayed and written thereinto; the information input means 1 can access a test processing request form stored in the first storage means 31 through the address checking means 34 and the password checking means 35.

As described above, a password entered from the user-side information input means 1 is to be stored in the third storage means 33 and as such, the device maker does not participate in password setting and only the responsible person on the user side manages a password. Accordingly, because a third party cannot access the test processing request form unless the party acquires the password, the leakage of secret information can be prevented.

In regard to the information input means 1 which the address checking means 34 and the password checking means 35 have permitted to access the test processing request form, the responsible person on the user side can see the details of the form displayed on the information input means 1 and write necessary information thereinto.

Further, on the device maker side, an address is entered from the information input means 2, whereby the followings are made possible: to access the information server 3 without a password; to display the details of a test processing request form for a user on a screen; and to write information into the request form. Therefore, both the device maker and user can share informaton and the device maker and user can exchange informaton involved in a test processing, on a test processing request form stored in the first storage means 31. Thus, informaton exchange can be made rapidly and reliably. Incidentally, a discriminating means 38 for discriminating between the user-side information input means 1 and the maker-side informaton input means 2 is disposed subsequently to the address checking means 34, whereby the device maker can access the first storage means 31 immediately after an address has been entered. However, the device maker may enter a password as in the case of the user.

On the user side, there can be two or more responsible persons who are able to access the test processing request form. Therefore the responsible persons may set auxiliary passwords and use the auxiliary passwords to access the test processing request form.

When the responsible person specifies an address through the information input means 1 and enters the password to access a test processing request form, the password checking means 35 transmits information about auxiliary password setting to the information input means 1 to make the input means display the information on the screen. If the user desires to set an auxiliary password, the user enters the auxiliary password to send it to the information server 3. When the information server 3 receives the entered password, the auxiliary password is stored in the fourth storage means 36.

After the auxiliary password is entered from the information input means 1 and stored in the fourth storage means 36, the responsible person notifies a certain assistant of the auxiliary password. When the assistant specifies an address from the information input means 1 to access the test processing request form, the address checking means 34 checks the specified address with the address stored in the second storage means 32. If the specified address agrees with the stored one, the auxiliary password checking means 37 makes the information input means 1 display the information to demand auxiliary password entry on its screen. When the assistant enters an auxiliary password, the auxiliary password is transmitted to the information server 3.

The auxiliary password checking means 37 checks the received auxiliary password with the auxiliary password stored in the fourth storage means 36. If the received password agrees with the stored one, the checking means 37 permits the assistant to access the test processing request form identified based on the address from the informaton input means 1, reads the test processing informaton form from the first storage means 31, and sends the informaton form to the information input means 1 to make the informaton input means 1 display on the screen, whereby it becomes possible to write information into the test processing information form. In contrast, if the received auxiliary password does not agree with the stored one, the access is rejected. Therefore, the auxiliary password is intended to bring a test processing request form into its open state, i.e. a state such that informaton can be displayed and written thereinto; the information input means 1 can access the test processing request form stored in the first storage means 31 through the address checking means 34 and the auxiliary password checking means 37.

User is responsible for the setting and management of auxiliary password as described above. Therefore the device maker does not need to manage the auxiliary password. Furthermore, a third party cannot access the test processing information unless the party acquires the password from the device user. Thus, the leakage of secret information can be prevented.

Further, when selecting an auxiliary password, a user-side responsible person decides an assistant who can use the auxiliary password and as such, the user of the device can restrict the assistant. Also, the device maker does not need to manage on this point.

1. A test processing information exchange method for exchanging information involved in a test processing performed by a device maker between the device maker and a user in a network through which a user-side information input means, a device maker-side information input means, and an information server are connected, the method comprising steps of:
the device maker preparing a test processing request form and entering the test processing request form and an address for addressing the test processing request form into the information server from the maker-side information input means; and
the user setting a password unique to the user and entering the password into the information server, the password intended for the user to enter the address from the user-side information input means, to arrive at the test processing request form, and to bring the test processing request form into its open state,
wherein the user enters the address and the password from the user-side information input means, and accesses the test processing request form in the information server, thereby to exchange the information involved in a test processing with the device maker on the test processing request form.

2. The test processing informaton exchange method according to claim 1, further comprising a step of:
the user setting an auxiliary password in addition to the password and entering the auxiliary password into the information server from the user-side informaton input means,
wherein the user enters the address and the auxiliary password from the user-side informaton input means, and accesses the test processing request form in the information server, thereby to exchange the informaton involved in a test processing with the device maker on the test processing request form.

3. The test processing information exchange method according to claim 1, wherein the information server includes at least: a first storage means for storing the test processing request form; a second storage means for storing the address for addressing the test processing request form stored in the first storage means; a third storage means for storing the password; an address checking means for checking an address entered from the information input means with the address stored in the second storage means; and a password checking means for checking a password entered from the information input means with the password stored in the third storage means, and
the user-side information input means is capable of accessing the test processing request form stored in the first storage means through the address checking means and the password checking means.

4. The test processing information exchange method according to claim 2, wherein the informaton server includes: a fourth storage means for storing the auxiliary password; and an auxiliary password checking means for checking an auxiliary password entered from the information input means with the auxiliary password stored in the fourth storage means, and
the user-side information input means is capable of accessing the test processing request form stored in the first storage means through the address checking means and the auxiliary password checking means.
